(19) United States
(12) Patent Application Publication
(10) Pub. No.: US 2018/0023785 A1
(43) Pub. Date: Jan. 25, 2018

(54) LED BULB, LAMP HOLDER, OR ADAPTOR INCLUDING A MODULE THAT EXTENDS BEYOND A SHADE, COVER, OR OTHER LIGHT BLOCKING ELEMENT TO PERMIT SIGNAL OR LIGHT TRANSMISSION TO OR FROM THE MODULE

(71) Applicant: Tseng-Lu Chien, Walnut, CA (US)

(72) Inventor: Tseng-Lu Chien, Walnut, CA (US)

(21) Appl. No.: 15/402,965

(22) Filed: Jan. 10, 2017

Related U.S. Application Data
(63) Continuation of application No. 14/606,242, filed on Jan. 27, 2015, now Pat. No. 9,541,260.
Application No. 14/606,242 is a continuation-in-part of application No. 13/367,758, filed on Feb. 7, 2012, now Pat. No. 8,967,831.
Application No. 13/367,758 is a continuation-in-part of application No. 13/296,508, filed on Nov. 15, 2011, now Pat. No. 8,562,158.
Application No. 13/296,508 is a continuation-in-part of application No. 13/296,469, filed on Nov. 15, 2011, now Pat. No. 8,711,216.
Application No. 13/296,469 is a continuation-in-part of application No. 13/295,301, filed on Nov. 14, 2011, now Pat. No. 8,760,514.

(51) Int. Cl. F21V 14/02; F21S 9/02; F21V 23/04; F21V 17/02; F21V 7/00; F21V 5/04; F21V 3/02; F21Y 101/00

(52) U.S. Cl. CPC F21V 14/02; F21V 5/048; F21S 9/02; F21V 3/02; F21V 23/045; F21V 23/0442; F21V 17/02; F21V 7/0066; F21V 29/70; F21Y 2115/10; F21K 9/23; F21Y 2101/00

(57) ABSTRACT

An LED bulb, lamp holder, or adaptor includes a module that extends beyond a shade, cover, or other light blocking element to permit signal or light transmission to or from the module.

This application is a continuation of U.S. patent application Ser. No. 14/606,242, filed Jan. 27, 2015, which is a continuation in part of U.S. patent application Ser. No. 13/367,758, filed Feb. 27, 2012, which is a continuation-in-part of U.S. patent application Ser. Nos. 13/295,301, 13/296,508, and 13/296,469, each filed on Nov. 15, 2011.

### BACKGROUND OF THE INVENTION

The three copending parent applications are related to the inventor's U.S. patent application Ser. No. 12/951,501 (“Lamp Holder has built in LED Night light”), and current application also has subject matter in common with the inventor's U.S. patent application Ser. No. 12/950,017 (“Multiple surface LED light”).

The following patent applications of the inventor are generally directed to LED lights and disclose structures that may be used in connection with the present invention: U.S. patent application Ser. Nos. 13/296,508, 13/295,301, 13/296,469, 13/162,824, 12/938,628, 12/887,700, 12/149,963 (U.S. Pat. No. 7,722,230), 12/073,095 (U.S. Pat. No. 7,726,869), 12/073,889, 12/007,076 (U.S. Pat. No. 7,726,841), 12/003,691 (U.S. Pat. No. 7,726,839), and 12/894,865.

Other prior art includes U.S. Patent and Patent Publication Nos. 7,524,089 (Park), Pat. No. 6,499,860 (Begemann), Pat. No. 6,220,722 (Begemann), Pat. No. 5,924,784 (Chliwnyj et al), 2003/0185020 (Stekelenburg), 2006/0146527 (Vanderschuit), and Pat. No. 6,648,496 (Elghoroury), Although the listed prior art discloses related subject matter, none of the prior art patents and publications discloses extendable constructions and more than one added function for an LED Bulb, lamp holder, or lamp holder adaptors to enable light beams or electric signals to be transmitted and received over a blocking-means, as described below.

Lamp holders and LED light bulbs that have a variety of functions are currently available in the marketplace. However, none includes both a built-in LED light and lamp holder with any combination of the following functions: (1) motion sensor; (2) remote control (RF); (3) Bluetooth remote control; (4) timer; (5) countdown; (6) seven-day programmable timer; (7) multiple area illumination; and (8) other electrical functions available from the marketplace to cause the LED light means to turn on and off and provide certain functions, duration, color, brightness, focus, and performance using optional parts and accessories.

The current invention preferably incorporates a combination of selected parts and accessories to create light effects in a LED lamp holder LED bulb with extendable bars. The parts and accessories include:

(a) plug parts of the lamp holder or lamp holder adaptor to connect with power source and get power;

(b) multiple parts for providing different illumination area(s);

(c) an extendable piece(s) having different geometric shapes and sizes;

(d) stopper means having a geometric shape and size to stop the extendable piece(s);

(e) energy storage means for DC energy, such as rechargeable or regular batteries;

(f) LED-unit(s) and LED-assembly(s) for desired brightness and size and shape;

(g) circuit means to provide a variety of desired function(s)

(h) conductive means and related parts and accessories for delivery of an electric signal;

(i) construction parts to fit the related mechanical or electric parts & accessories within;

(j) motion sensor means;

(k) remote control means;

(l) Bluetooth remote control means;

(m) timer means;

(n) countdown means;

(o) seven-day programmable timer means;

(p) other switch means or sensor means;

(q) integrated circuit (IC) means;

(r) digital data record and storage means;

(s) optics means including all kinds of lens, stencil, window, opening, cut-outs, reflective lens, retro-reflective lens, opaque lens, condensing lens, convex lens, concave lens, or adjustable focus means lens, or any other optics means that may be applied to an LED light means;

(t) s heat sink to ventilate heat from the LEDs heat to outside the unit;

(u) receiving parts and accessories of a lamp holder or lamp holder adaptor; (v) body parts that are transparent, translucent, opaque, and/or anti-flammable;

(w) heat isolating means;

(x) light block-out means;

(y) switch means or sensor means available from the marketplace;

(z) linkable means to cause multiple LED lights or lamp holders to illuminate at the same time.

The current invention includes an extendable piece(s) to enable added functions to be provided without interference from the a lamp shade, lamp glass, or lamp cover, which is normally designed to cover an incandescent bulb's ugly shape. The extendable piece(s) are necessary to provide the lamp-holder or LED Bulbs with extra space to install “added functions” without been blocked by the lamp-shade, lamp-glass, lamp cover or any other block-out-the-light means. The current invention's extendable piece(s) can be positioned at a rear end of a lamp holder or lamp holder adaptor to enable plug parts to get power from a power source, or at a front of a lamp bulb to enable a sensor means, switch means, or RF receiving means to get an electric signal over a lamp shade, lamp cover, lamp glass, etc. that constitute a blocking means for light emitted by the light fixture.

A main feature of the current invention is thus the provision of (1) an LED bulb; (2) lamp holder; or (3) lamp holder adaptor to overcome blocking-means and enable the LED bulb, lamp holder, or lamp holder adaptor to add “Extra Functions” without block out by a lamp shade, lamp cover, lamp glass, or other blocking means.

The current invention further provides an LED bulb which has an extendable piece to allow the LED bulb to overcome the blocking means. The LED bulb may be connected with a lamp holder or lamp holder adaptor to get power for illumination.

The current invention further provides a lamp holder which has an extendable piece to allow the lamp holder to overcome the blocking means, the lamp holder having one end connected with a house electricity system and one end connected with light-source means.

The current invention further provides a lamp holder adaptor which has an extendable piece to allow the lamp holder adaptor to overcome the blocking means and provide added functions within body parts, the lamp holder adaptor having one end connected with an existing lamp holder, and one end connected with a light-source means.

### BRIEF DESCRIPTION OF THE DRAWINGS

FIGS. 1A to 1C shows a first group of embodiments in which an extendable piece(s) are provided in an LED bulb, lamp holder, and lamp holder adaptor.

FIGS. 1D to 1V show details of an LED bulb, lamp holder, and lamp holder adaptor that may be applied to the embodiments of FIGS. 1A to 1C.

FIGS. 2A to 2D show a length difference when the extendable piece(s) of the preferred embodiments is extended-out versus when the extendable piece(s) is not extended.

FIGS. 3A, 3B, 3C, 3D, 4A, 4B, 4C, 5A, 5B, 5C, and 5D are taken from above-listed copending application of the inventor and show LED bulbs with front extendable piece(s) arranged to install sensor heads, switch means, photo sensor, RF receiver(s), Bluetooth receiver(s), timer receiver means, countdown means, seven-day programmable timer means, and other sensor or switch means available from market-available parts.

FIGS. 6A, 6B, 6C, 6D are taken from above-listed copending applications of the inventor and show comparisons of LED bulbs with front extendable piece(s) and LED bulb without front extendable piece(s) that cannot overcome the blocking mean(s).

It is to be appreciated features disclosed in the inventor's related applications, including patent drawings, detailed description and content may be added to the presently disclosed embodiments without departing from the scope of the current invention, and that the invention is not limited to the current drawings, detailed description, and content.

### DETAILED DESCRIPTION OF THE PREFERRED EMBODIMENTS

The current invention relates to a device having an LED and an extendable construction that overcomes blocking by a lamp cover, lamp shade, lamp glass, or other blocking means which block out light beams or electric signals from being transmitted therethrough, and enabling more than one function to be provided without interference from the blocking means. The current invention may be in the form of an LED bulb, lamp holder, or lamp holder adaptor(s).

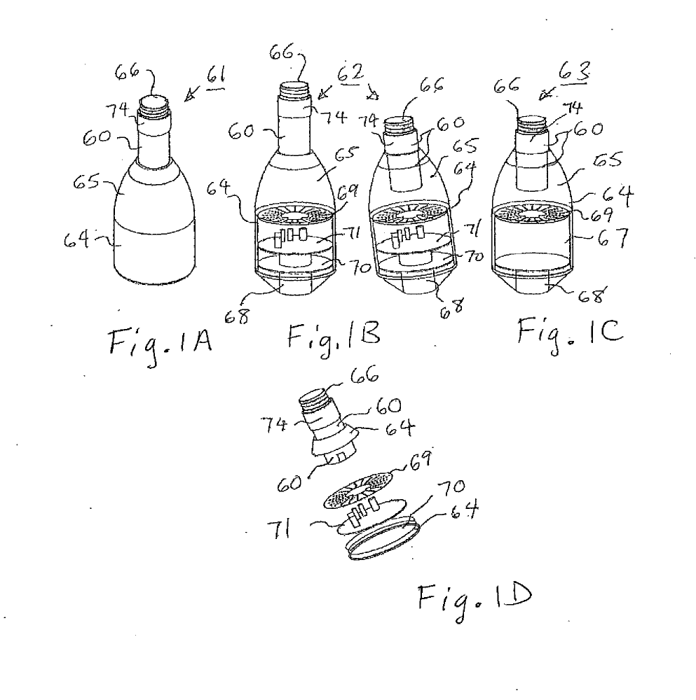

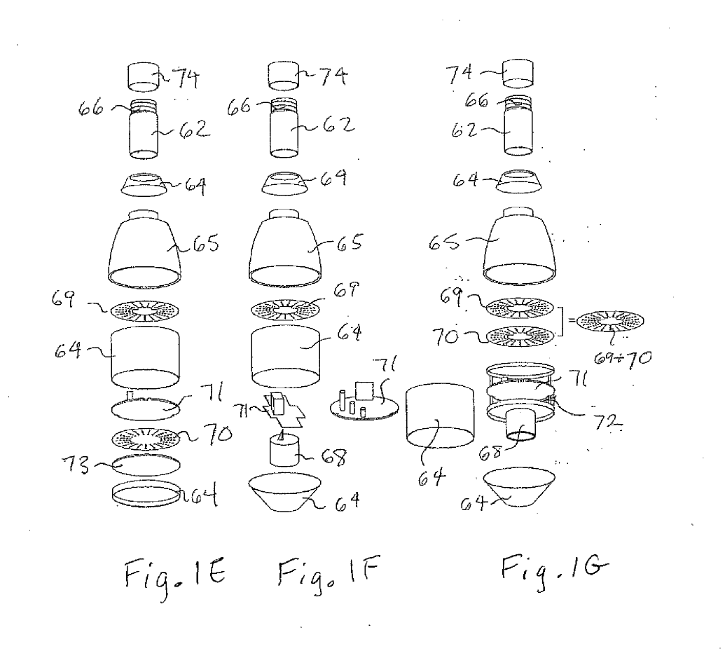

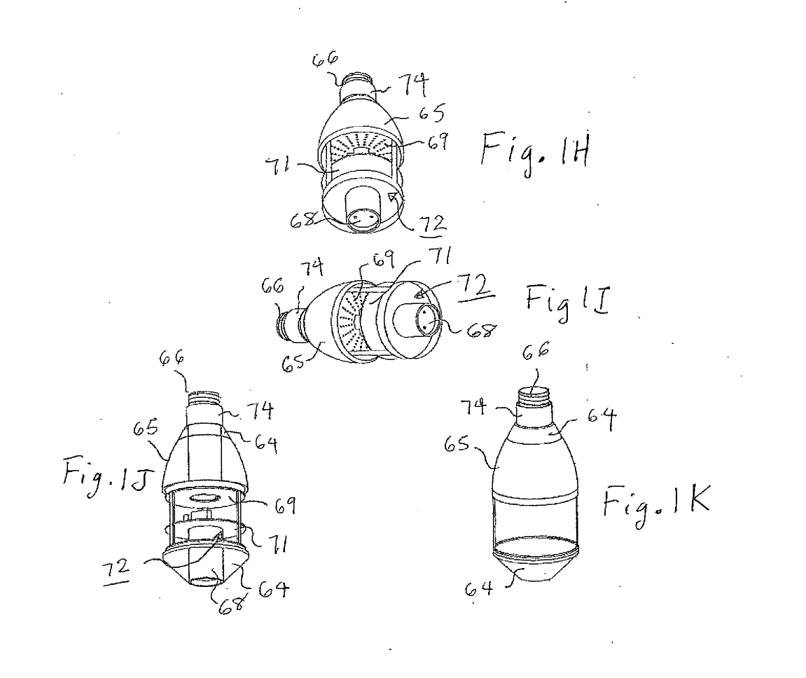

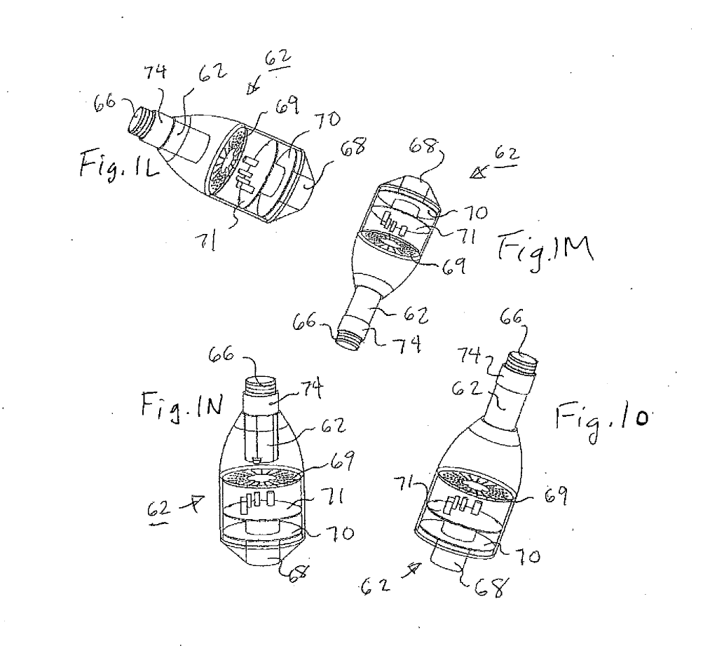

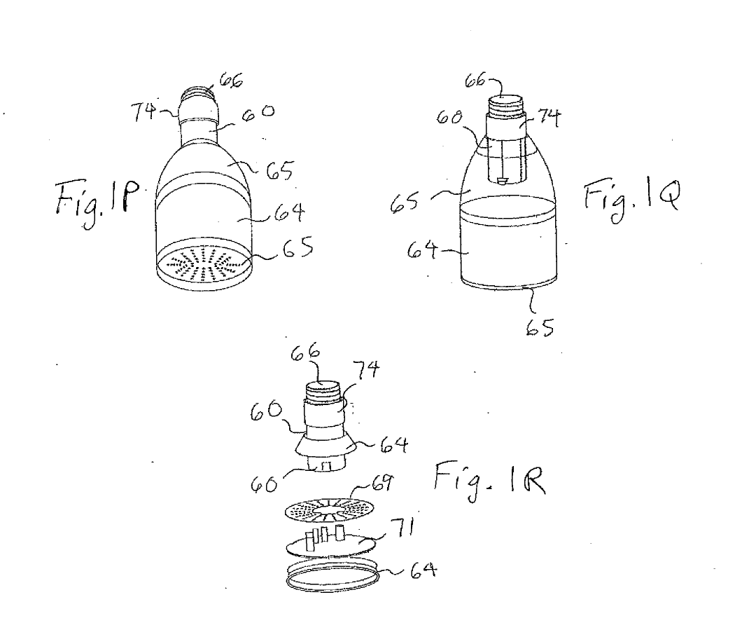

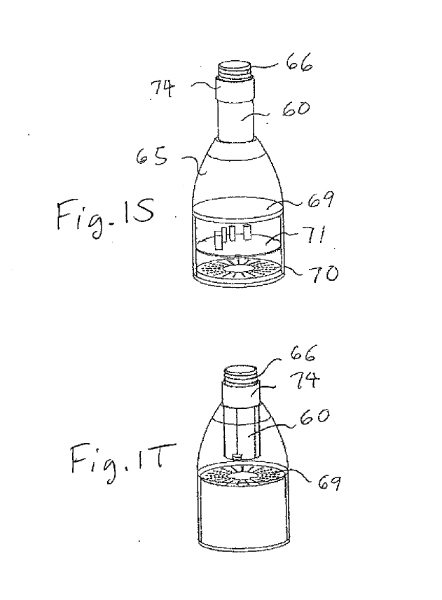

FIGS. A to 1C respectively show a first group of embodiments having extendable piece(s) 60 with optional stoppers 74, the embodiments including an LED bulb 61, lamp holder 62, and lamp holder adaptor 63. As illustrated in FIGS. 1A to 1C, the respective bodies 64 of the LED bulb 61, lamp holder 62, and lamp holder adaptor 63 may include at least one glow area 65, and conventional means such as a screw, bayonet, or pin type base 66 for plugging the bulb, lamp holder, or adaptor into a socket. As shown in FIG. 1B the adaptor may include adaptor means 68 to receive the base of another bulb, lamp holder, or adaptor and/or, as shown in FIG. 1C may include a 360 degree IR motion sensor.

FIGS. 1D to 1V show details of LED bulbs, lamp holders, and lamp holder adaptors that may be applied to the preferred embodiments of FIGS. 1A to 1C. For example, 1D shows an LED bulb construction 61 with two LED assemblies 69, 70 and a circuit board 71 therebetween, a housing part, and the extendable construction 62 extending from the above-mentioned screw, bayonet, or pin type plug means 66 for connection to a socket. FIGS. 1E to 1G show similar extendable constructions, with FIG. 1G specifically showing added function means 72 in the form of (1) a motion sensor; (2) an RF remote control; (3) a BlueTooth remote control; (4) a timer; (5) a countdown timer; (6) a seven-day programmed timer; (7) an LED on/off control; and (8) digital data recording or storage. Other features include optional optics means 73 as shown in FIG. 1E, and stoppers 74 as shown in FIGS. 1E to 1G FIGS. 1F to 1V show features corresponding to FIGS. 1E to 1R that also may be applied to an LED bulb, lamp holder, or lamp holder adaptor of the type shown in FIGS. 1A to 1C.

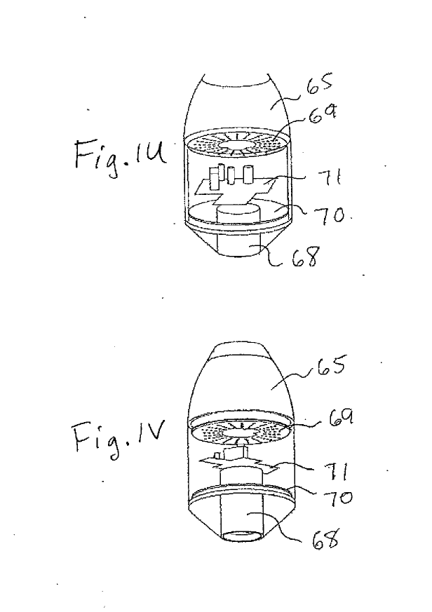

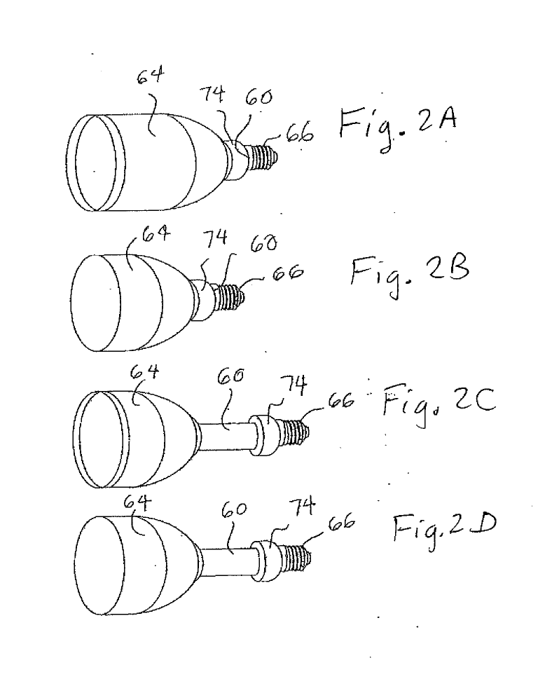

FIGS. 2A and 2B show unextended LED bulbs, lamp holders, or adaptors corresponding to those of FIGS. 1A to 1C. FIGS. 2C and 2D show the same LED bulbs, lamp holders, or adaptors of respective FIGS. 2A and 2B, but in which the extendable pieces have been extended to illustrate the resulting length difference.

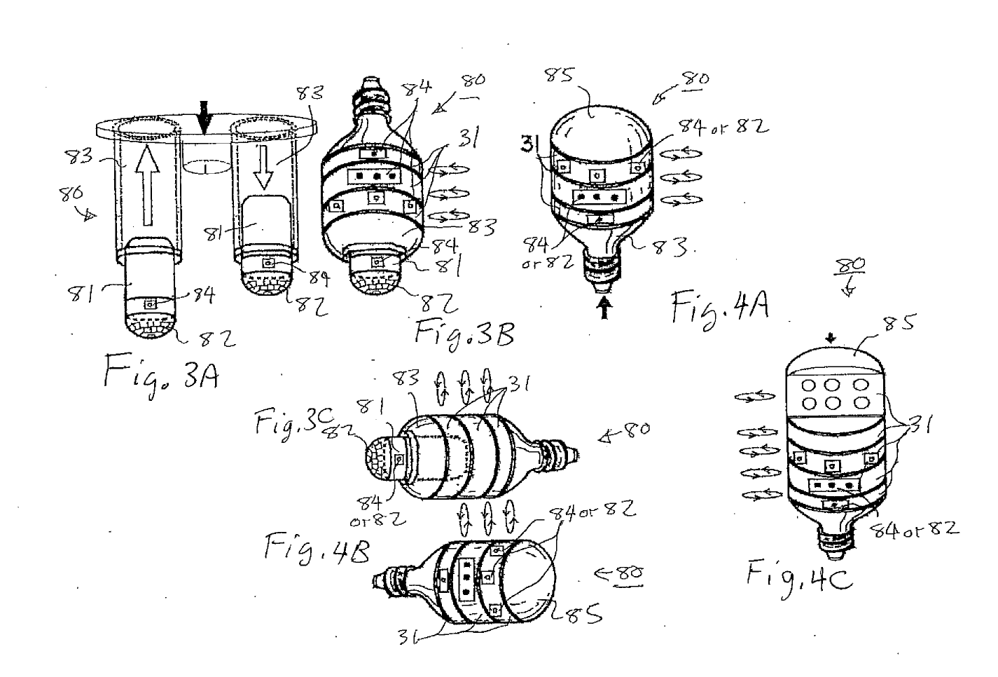

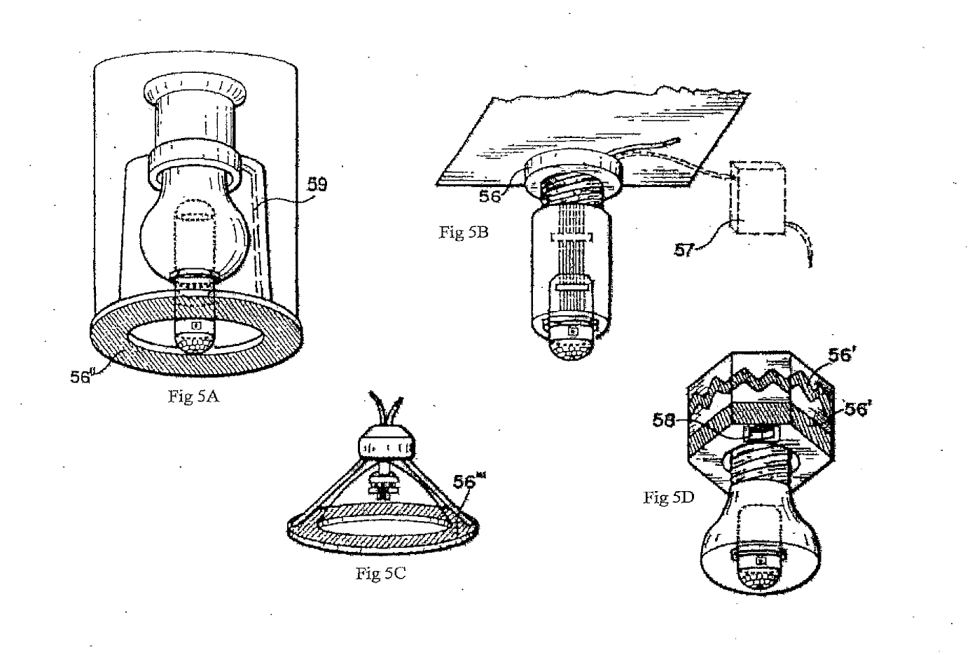

FIGS. 3A, 3B, 3C, 3D, 4A, 4B, 4C, 5A, 5B, 5C, and 5D show an LED bulb with front extendable piece(s) 81 and glow areas 85 or LED arrays 87 corresponding to the LED bulb disclosed in the above-cited inventor's copending parent U.S. patent application Ser. Nos. 13/295,301, 13/296,469, and 12/296,508 to install sensor heads, switch means, photo sensor, RF receiver(s), Bluetooth receiver(s), timer receiver means, countdown means, seven-day programmable timer means, and other sensor or switch means available from market available parts. As shown in FIGS. 3A-3C and 4A-4C, the sensors and/or a camera 82 or 84 can be extended or retracted and rotated to avoid interference by lamp shades, lamp covers, lamp walls, or other blocking means 83 that otherwise might block a field of view of the camera or sensor. The device may have multiple rings, each of which is separately rotatable to enable separate rotation of the sensor(s) and difference camera heads, as shown in FIGS. 3A-3C and 4A-4C. As shown in FIG. 3D and FIGS. 5A-5D, the extension may enable the position, orientation, or angle of the sensor or camera head to be varied, or enable the sensor to be extended while the lighting feature is within a shade, and the device may further include external light elements such as lighting elements 85 and 36, as well as additional sensors such as sensor 30, all shown in FIG. 3D, and lighting elements 56′, 56″, and 56′ shown in FIGS. 5A, 5C, and 5D. FIG. 5B also shows an external circuit means for providing additional control functions and a base 56 through which power is supplied to the bulb.

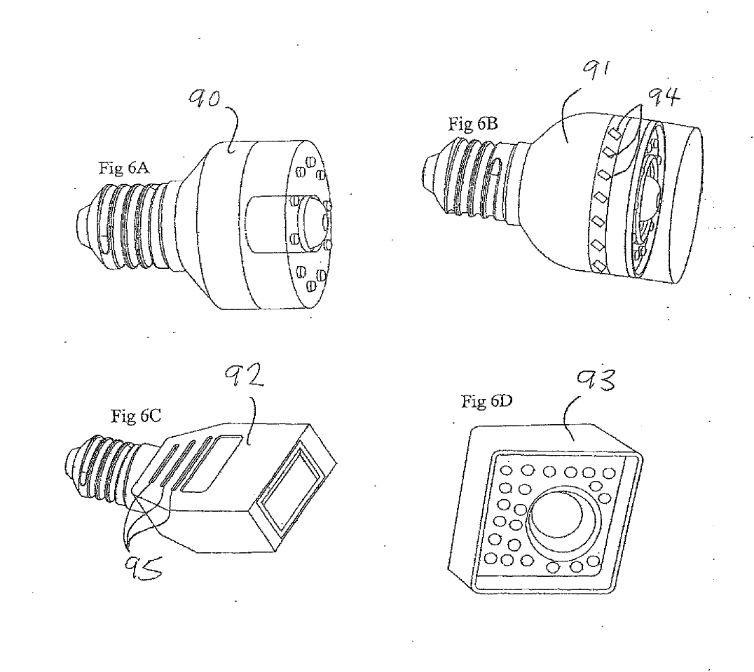

FIGS. 6A, 6B, 6C, 6D show alternative LED bulbs 90, 91, 92, and 93, including high power LED bulbs 91 and 93 with ventilation openings 94 and 95 as shown in FIGS. 6A and 6B, as also disclosed in copending parent U.S. patent application Ser. No. 13/296,469. As shown in the drawings, the LED light device of the preferred embodiments may include one extendable construction to allow sensor means or switch means or light means to overcome blocking means in the form of a lamp cover, lamp shade, lamp glass, or light fixture that would otherwise block light or electrical signal transmission from the extendable construction. The blocking means may further include a stencil, opening, cover, decorative means, lens, or other objects which have equivalent function of the blocking means in interfering with light beam or electric signal transmission.

The LED light device of the preferred embodiments may incorporate any desired group or combination of selected parts and accessories to cause areas of the bulb, holder or adaptor body to glow, and may further include:

(a) plug parts to connect with a power source through a socket, the plug parts being in the form of a standard screw plug or one that tolerates a degree of twisting to adjust the orientation, direction, or position of the bulb, holder, or adaptor, or any other type of plug parts including a pin-plug, position-and-twist plug, or other market available type of plug parts;

(b) multiple parts for multiple illumination areas;

(c) extendable pieces of different geometric shape and size;

(d) stopper means having a desired geometric shape and size to stop the extendable piece(s) from extending too far;

(e) energy storage means for DC energy such as rechargeable or regular batteries;

(f) LED-unit(s) and LED-assembly(s) with desired brightness, size, and shape;

(g) circuit means for a variety of desired functions;

(h) conductive means and related parts and accessories for delivering an electric signal;

(i) construction parts for fitting related mechanical or electric parts and accessories within the bulb, lamp holder, or adaptor;

(j) motion sensor means;

(k) remote control means;

(l) Bluetooth remote control means;

(m) timer means;

(n) count down means;

(o) seven-day programmable timer means;

(p) other switch means or sensor means;

(q) integrated circuit (IC) means;

(r) digital data record and storage means;

(s) optics means including all kinds of lens, stencil, windows, opening, cut-outs, reflective lens, retro-reflective lens, opaque lens, condensing lens, convex lens, concave lens, or adjustable focus lens, or any other optics means that may be applied to an LED light means;

(t) a heat sink to ventilate heat from LEDs out of the light unit;

(u) receiving parts and accessories for a lamp holder or lamp holder adaptor including a screw base, bayonet base, pin-base, or position-and-twist base;

(v) transparent, translucent, opaque, and/or anti-flammable body parts;

(w) heat isolating means;

(x) light blocking means;

(y) switch means or sensor means available from the marketplace;

(z) linkable means to link multiple LED lights or lamp holders for illumination at the same time.

The LED light device with extendable construction and added functions, may take the form of a desk lamp, table lamp, reading lamp, mirror lamp, floor lamp, wall lamp, outdoor lamp, indoor lamp, ceiling lamp, chandelier lamp, track lighting, garden lamp, seasonal lamp, or other lamps available from the marketplace.

Those skilled in the art will appreciate that the extendable construction may be on at least one end, both ends, or any desired surface(s) of the LED bulb, lamp holder, or lamp holder adaptor.

The related parts and accessories for the added functions, including circuitry, electric parts, and accessories may be arranged to fit within the a compartment(s) in the device or in the extendable construction space.

The LED light device of the invention may include a single side, double side, or multiple layer printed circuit board with LED(s) having a desired shape, specifications, brightness, luminance, power consumption, color, color K-temperature, viewing angle, and/or size to meet market requirement(s).

The plug parts of the LED bulb, lamp holder, or lamp holder adaptor may have an extra tolerance with respect to twisting so as to allow the LED bulb, lamp holder, or adaptor to be moved to a position in which the sensor means and/or switch means are aimed at a desired location, orientation, or direction to receive electric signals.

Finally, the extendable construction may be fixed at different lengths by incorporating appropriate stopper means or lock means to stop or lock the extendable construction at a desired extended length.

It will appreciated that the current invention should not be limited by the current drawings, detailed description, and that modifications and variations may still fall within the scope of the current invention.

I claim:

1. An LED light device, comprising:
a LED light device body and contact terminal(s) for electrically connecting the LED light device to a power source upon insertion of the LED light device into a light socket;
an extendable part arranged to extend from and to be retracted into said light device body,
wherein said extendable part or light device includes circuitry and an electronic unit which has at least one of (1) wireless communication by wifi, Bluetooth, internet network, Z-wave, wifi; (2) camera with or without camera flash/strobe light system; (3)sensor, switch; (4) a remote control; (5) an integrated circuit, circuit, circuitry; (6) a digital data recording; (7) storage device; (8) Camera flash/strobe light; (9) reply or display device;
wherein at least one LED is arranged in the light device body or-and extendable parts to offer at least one part of device illumination;
wherein said light device need to overcome any of blocking objects that is (a) a built-in for existing bulb or-and bulb-socket or-and device parts, or (b) made of an outside building's material that interferes with (aa) transmission and reception of wireless signals to and from said electronic unit or (bb) light emit directions. when said extendable part is retracted into or extend out the light device body, thus interfering with operation of the electronic unit;
wherein when said extendable part is extended out or retracted into from said light device body, said blocking objects no longer interferes with (aa) transmission and reception of wireless signals to and from said electronic unit or (bb) interferes with light emitting direction, thus allowing operation of the electronic unit without interference by the blocking objects; and
wherein the LED light device is an LED bulb or LED bulb-adaptor both at least has one of the male-plug to insert the female bulb-socket to connect power source.

2. An LED light device as claimed in claim 1, further comprising male plug-parts or bulb-base is one of a screw type, a pin type, a position-and-twist type which has elastic function.

3. An LED light device as claimed in claim 1, further comprising stopper design for stopping extension or retraction of said extendable part from the light device body.

4. An LED light device as claimed in claim 1, further comprising a heat sink or ventilation fan for conducting heat to an outside of the light device body.

5. An LED light device as claimed in claim 1, wherein the LED light device further comprising optics element(s) for modifying light from said at least one LED, said optics element(s) including at least one of concave, convex, or condensing lens, refractive or-and reflective lens, stencil, window, opening, cut-out, reflector, retro-reflector, adjustable focus mechanism, motor-gear-set assembly, clock movement assembly, speed controller.

6. An LED light device as claimed in claim 1, wherein the LED light device is apply for or fit into at least one of a desk lamp, table lamp, reading lamp, mirror lamp, floor lamp, wall lamp, outdoor lamp, indoor lamp, ceiling lamp, chandelier lamp, track lighting, garden lamp, and seasonal lamp including light string for multiple of said LED light device(s) or LED bulbs.

7. An LED light device as claimed in claim 1, wherein the extendable part extends from one end, both ends, front end, rear end, or at least one surface of the LED bulb, lamp holder, or lamp holder adaptor.

8. An LED light device as claimed in claim 1, wherein said circuitry and additional electric parts and accessories are fitted within compartments or space in said LED light device.

9. An LED light device as claimed in claim 1, wherein said extendable part includes a single sided, double sided, or printed circuit board on which said at least one LED is mounted.

10. An LED light device as claimed in claim 1, wherein said male-plug or bulb-base include construction for enabling twisting of the plug more degree or circles basing on the elastic conductive electric-pole to a selected orientation when the LED light device including the LED Bulb or LED bulb-adaptor is plugged into a bulb socket, thereby enabling the sensor, wireless receiver, remote control receiver, Bluetooth receiver, IR or RE receiver, sensor, motion detector or camera in the LED bulb or LED bulb-adaptor to be aimed in a desired direction.

11. An LED light device as claimed in claim 1, further comprising lock to lock the extendable part at least one predetermined extension position or length.

12. An LED light device as claimed in claim 1, the said LED light source has more than one piece has desired white color, multiple color with desired circuitry with IC controller to make the more than one LED to turn-on and turn-off at desired timing, cycle, duration, brightness, color changing, mixing color, sequential flashing ; or device has programed IC chip to make different LEDs turn-on and turn-off with desired functions by control the power-on or power-off under predetermined programed.

13. An LED light device as claimed in claim 1, wherein said digital recording and storage device includes at least one of a (1) camera with or without camera flash/strobe light system, (2) digital video recorder, (3) pin-hole camera, (4) at least one of a tape, CD, SD card, Micro SD card, memory stick to storage or memory digital data, (5) device can deliver the digital data by wired or wireless system, communication to electric device including phone, computer, ipad, consumer electric, communication products (6) device can storage image, sound , digital data, (7) device can play, reply, display the digital data.

14. An LED light device, comprising:
A light device electrically connecting power source;
an extendable parts arranged to extend from and to be retracted into said light device body on the front or-and rear end of the said LED light device to overcome any block-object(s) which interfere with (1) the electric signal receiving or transmission, or (2) the LED light beam traveling direction,
wherein said light device has extendable parts and circuitry and an electronic unit which has at least one of (1) wireless electric-signal communication by the blue-tooth, wifi, internet communication, Z-wave; (2) sensor; (3) a remote control; (4) IR or RE receiver; (5) the blue-tooth or wifi receiving device; (6) an integrated circuit; (7) a digital data recording or-and storage device; (8) SD card related device (9) device for playback or display device, (9) camera device to take photo or video with or without camera flash/strobe system, (10) extra LEDs, (11) circuitry for extra LEDs to turn-on and turn-off at different timing, for different functions, different color, different brightness, different cycle, dutration, period of time, countdown, sequential (12) extra LEDs change functions, performance, color, effects by shutdown power or turn on power with pre-program power (13) battery or batteries with or without rechargeable functions back up or power fail or power shutdown or power bank (14) extra port for receiving different plug for desired function including USB ports to charge battery or batteries or offer power from battery or batteries;
at least one LED arranged in the light device body or-and extendable part to emit light beams out from at least one of body parts or areas including front, side, top, countour, sides wall;
a blocking object(s) is a built-in (aa) the said existing LED light device or (bb) building's material outside of said LED light device that interferes with (1) transmission and reception of wireless electric signals to and from said electronic unit, or (2) interferes with light beam passing direction when said extendable module is retracted-into or extend-out the light device body, thus interfering with operation;
wherein when said extendable parts is extended-out or retracted-into from said light device body, said blocking object(s) no longer interferes with transmission and reception of wireless electric signals to and from said electronic unit, or interferes with light beam passing direction , thus allowing operation without interference by the blocking object(s);
wherein said blocking object(s) is one of (1) a device's housing, lamp cover, lamp shade, lamp glass, and fixture, or (2) one of the building material outside of the light device, and
wherein the LED light device is an LED bulb or LED bulb adaptor.

15. An LED light device, comprising:
a light device electrically connected to a power source;
an extendable part arranged to extend from and to be retracted into said light device body on the front of the said LED light device to overcome any block object(s) interfere the electric signal receiving or transmission or interfere the light beam emit directions,
wherein said light device has circuitry or-and an electronic unit which has at least one of (1) wireless electric-signal communication by the blue-tooth or wifi or internet communication or any wireless network, (2) at least one of a sensor, (3) a remote control, (4) IR or RF receiver, (5) The blue tooth or wifi receiving device, (6) an integrated circuit, (7) a digital data recording and storage device, SD card related parts, (8) device to reply or display device, (9) extra LEDs or diodes, (10) circuitry to turn-on and turn-off different LED light source on different timing, cycle, duty, color, brightness;
at least one LED arranged in the light device body or-and extendable part to make the light beam emit out from more than one parts of the said LED light device including front, side, top, countour, sides wall;
wherein said blocking-object(s) is one of (1) light device's housing, a lamp cover, lamp shade, lamp glass, and light device's fixture or (2) building material outside of the said light device;
wherein the LED light device has a second extendable part on a rear end of the LED light device that can extend or retract to enable further extension of the LED light device to overcome the blocking-object(s); or the second extendable parts on a rear end to add the battery or batteries with or without rechargeable capability for back-up or power-fail or power-shutdown or power-bank functions which incorporate with or without the extra port for receiving different plug for desired function including USB ports to charge battery or batteries or offer power from battery or batteries; and
wherein the LED light device is an LED bulb or LED bulb adaptor.

16. An LED light device as claimed in claims 14 and 15, further comprising a backup energy storage device built-in on the rear extendable module of the LED device to provide continuous backup power when the LED light device power source is off or shut-down and turn on the said LED light device by controller from a sensor, remote controller, Bluetooth receiver, wifi receiver, wireless controller or power failure circuit unit.

17. An LED light device as claimed in claim 14, 15, the backup energy storage device is a non-rechargeable or rechargeable battery, and the said battery or batteries with or without rechargeable capability for back-up or power-fail or power-shutdown or power-bank functions which incorporate with or without the extra port(s) for receiving different plug for desired function including USB ports to charge the said inside device's battery or batteries or supply the power from inside battery or batteries to outside devices' or products' energy storage kits.

18. An LED light device as claimed in claim 14, 15, the said LED light source has more than one piece has desired white color, multiple color with desired circuitry with IC controller to make the more than one LED to turn-on and turn-off at desired timing, cycle, duration, brightness, color changing, mixing color, sequential flashing or by programed IC chip to make different LEDs turn-on and turn-off with desired functions by control the power-on or power-off under predetermined programed.

19. An LED light device as claimed in claim 14, 15, wherein the LED light device is a LED bulb apply for or fit into at least one of a desk lamp, table lamp, reading lamp, mirror lamp, floor lamp, wall lamp, outdoor lamp, indoor lamp, ceiling lamp, chandelier lamp, track lighting, garden lamp, and seasonal lamp including light string for multiple of said current LED light device(s).

20. An LED light device as claimed in claim 14, 15, wherein the LED light device is a LED bulb for light string has desired number of said LED bulb has different time to turn on the said LED bulbs to get different color, different brightness, different functions, different moving effects, different parts of LED bulb for illumination, different sequential chasing, flashing, random, fade in and fade out by control the power source under pre-programed Circuit and IC design.

21. An LED light device as claimed in claim 14, 15, wherein the LED light device is a LED bulb for light string which the light string has built-in light bulb base and Light Bulb clear lens which is sealed or twisted tightened to prevent people electric-shock.

22. An LED light device as claimed in claim 14, 15, wherein the LED light device is a LED bulb has more than one LEDs inside to get desired color, light functions, light brightness or light performance including color changing or mix-color by turn-on and turn-off power source.
